(19) United States
(12) Patent Application Publication
(10) Pub. No.: US 2012/0217214 A1
(43) Pub. Date: Aug. 30, 2012

(54) Spice Cabinet Library

(76) Inventor: Julie Thomsen, Austin, MN (US)

(21) Appl. No.: 13/364,833

(22) Filed: Feb. 2, 2012

Related U.S. Application Data
(60) Provisional application No. 61/447,294, filed on Feb. 28, 2011.

(51) Int. Cl. A47G 29/00; A47B 88/04; G09F 3/00; A47B 96/02

(52) U.S. Cl. 211/79; 40/299.01

(57) ABSTRACT

A spice container storage system comprising of a series of frame shelving units arranged adjacent to one another that slide in and out of a cabinet on drawer guides located on the top and/or bottom of each frame. The front of each frame has a unit retrieval hole which serves as a handle. The device has two positions: a storage position and a spice access position. In the accessible position, the spice containers stored on the shelves are easily visualized and can be removed from either side of the frame shelving unit. Each shelf employs railings and an open central channel to keep the spice containers aligned and prevent them from accidentally becoming dislodged. The spice containers store in a compact, vertical space to improve storage efficiency of the cabinet, which can be an independent structure or integrated into existing cabinetry.

### CROSS REFERENCE TO RELATED APPLICATION

This application claims the benefit of U.S. Provisional Application No. 61/447,294 filed on Feb. 28, 2011, entitled “Spice Library.”

### BACKGROUND OF THE INVENTION

1. Field of the Invention

The present invention relates to spice container organizational systems for use in a residential, commercial or industrial kitchen. More specifically, the present invention is a retractable spice container holding system for use in a kitchen cabinet or as an independent structure for storing an assortment of herb and spice containers. The present device improves upon existing spice storage devices by utilizing vertical space inside the cabinet structure, increasing the overall amount of storage space available in the cabinet for other storage needs.

2. Description of the Prior Art

The preparation of many foods and dishes require the addition of selected herbs and spices. Cooking and baking with herbs and spices has become very popular as the addition of choice seasonings can enhance the flavor of certain foods. Some herbs and spices have distinct characteristics such as a strong flavor profile or an unmistakable color or aroma. Other herbs and spices have a more subtle flavor, but are necessary additions in order to achieve the particular desired taste of the dish. Cooks, chefs and bakers often acquire a vast assortment of herbs and spices in their kitchens as to have the correct ingredients on hand in the event that a recipe calls for a particular seasoning.

A common problem encountered during cooking or baking is that an individual has a difficult time locating a particular spice in his or her kitchen cabinets. The various containers for different spices can be unique in shape and size. Smaller spice containers can be hidden by larger spice containers or other items in the cabinet may obscure the desired spice container from view, leading an individual to think that he or she does not have the desired spice on hand and needs to purchase more. This game of spice container hide-and-seek becomes frustrating and tiresome and often leads unnecessary time spent searching for a particular container or duplicate purchasing of spices. Furthermore, it is bothersome, and often challenging, to try and keep the vast array of cooking spices in a cabinet organized. Each time a recipe calls for a single spice, the individual must seek out the required ingredient, shifting through and moving other spice containers within the cabinet during the process. It is common for spice containers to fall from the cabinet while a search for the desired spice is underway, adding to user frustration. An individual may find this annoying and could also result in a damage to a container if impact with a counter top or floor results from dislodged containers while searching, creating unnecessary mess, time spent and expense.

A spice rack provides a solution to the problems associated with an unorganized spice menagerie, which as previously noted can be problematic and difficult to otherwise organize and navigate. Spice racks are utilized to create an organizational system for sorting and storing various spice containers. A spice rack can provide an individual with easy access to the spice containers and can simplify the process of locating a desired spice. Many different models of spice racks exist. Some are intended to sit on a counter top and rotate around an axis, providing an individual with access to all the spices held in the rack with a simple spin of the device. Other spice racks resemble shelving units that hang on a kitchen wall or on the inside of a cabinet door. Further still, instead of occupying counter top or kitchen cabinet space, a spice rack can also be built into a kitchen drawer or hung from the underside of an upper cabinet.

The present invention is an organizational and storage system for holding an assortment of herb and spice containers in an efficient manner. The device comprises of a series of frame shelving units, arranged adjacent to one another, that slide into and out of a cabinet structure, granting access to the spice containers that are stored upon the shelves from either side of the shelving unit. The cabinet structure may be a stand-alone structure that accompanies the drawers, or alternatively may be integrated into existing or new kitchen cabinetry. On the top and bottom of each frame are drawer guides that attach the frames to the cabinet structure. The drawer guides allow for the frames to slide in to and out of the cabinets with ease. Each frame comprises of multiple shelves and each shelf has railings on either side of an open channel to prevent the spice containers from accidentally falling out of the channel while an individual accesses the shelf. Both embodiments of the structure, independent or built-into existing cabinetry, conserve kitchen storage space by employing multiple tiers of shelving in the shelving frames to efficiently house a plurality of different spices and herbs, which can take several container shapes and forms. The spice containers are stored in a compact, vertical space, increasing overall storage capacity and organization.

Many different spice racks are presently available that attempt to address the issues concerning the organization and storage of kitchen spice collections. For example, U.S. Pat. No. 5,671,987 to Hommes describes a retractable spice bin which is capable of sliding in and out of a kitchen cabinet. The spice bin device has six sides: a top; bottom; two side walls; a front, which has a handle attached it; and a back side, which faces the interior of the kitchen cabinet in which the device is housed. One side wall of the device has a cutout portion, granting access to the interior of the bin. The cutout is sufficiently large to grant access to the interior of the bin. However, a portion of the side wall remains along the edges of the side of the bin, forming a barrier designed to keep any spice containers inside the bin as the bin slides in and out of the cabinet. The top of the spice bin mounts to a slide rail that allows for the spice bin to easily slide out from the cabinet. Once the bin slides out of the cabinet, an individual can access the contents of the bin from the side of the spice bin.

The Hommes device provides individuals with a spice container storage system comprised of a series of retractable spice bins. The spice bins described by Hommes can be arranged such that multiple bins are aligned adjacent to one another and are capable of holding a variety of different sized spice containers. The Hommes spice bins only provide a single surface upon which to store spice containers, i.e., the bottom of each bin. In essence, the only added benefit to using the Hommes device, over traditional spice container storage methods, such as storing the various spice containers on a single shelf in a cabinet, is that the Hommes device allows for an individual to organize and easily access spice containers. The Hommes device does not necessarily better utilize cabinet space than traditional methods for storing spice containers in a cabinet. Conversely, the present invention utilizes cabinet space more effectively because the present invention employs multiple tiers of shelving in each of the shelving frames. Thus, spice containers are stored in a compact, vertical space inside the cabinet, increasing the overall amount of storage space in the cabinet.

U.S. Pat. No. 4,714,305 to Service describes a spice rack device that is capable of being stored behind a kitchen appliance, such as a kitchen range or a refrigerator. The spice rack is readily accessible and easily collapsible. The device comprises an exterior cabinet with an open side, inside which is an inner receptacle member with an open top, inside which is a spice rack. To use the Service device, an individual laterally slides the inner receptacle member out from the side of the exterior cabinet, which is stored behind a kitchen appliance, such as a kitchen range. Next, the individual vertically slides the spice rack upwards from inside the inner receptacle member, accessing the spice containers housed on the spice rack of the device. The shelves of the spice rack are either fixed or adjustable and can accommodate a variety of different sized spice containers. When an individual finishes accessing the spice rack, he or she can collapse the device back to its compact state.

The Service device is intended to be stored behind a kitchen appliance for the purpose of conserving cabinet space. The device is a standalone spice rack that can be stored either behind or next to an appliance. Not all kitchens are capable of accommodating such a device as it is common for there to be no space next to or behind a kitchen appliance to store the Service device. The present invention utilizes cabinet space for the storage of herbs and spices. The present invention takes up less cabinet space than the myriad of unorganized spice containers when the spice containers are not arranged in a spice rack, by organizing the containers into a frame shelving unit, thus utilizing vertical space in the cabinet. The present invention can be used in all kitchens, including small kitchens with little cabinet space by utilizing a single shelving frame of the present invention instead of the plurality of shelving frames.

U.S. Pat. No. 4,653,818 to DeBruyn describes an organization and storage system for dry goods that utilizes kitchen cabinet shelving comprising a series of hanger plates that hold a collection of bucket-style storage bins. Inside a kitchen cabinet is a set of shelves. Located on the underside of each cabinet shelf is a sliding rail to which a hanger plate of storage bins attaches. Hangers, which hold the storage bins, hang down from the hanger plate. Each bin is easy to clean, reusable and has a water resistant lid. To use the DeBruyn device, an individual slides the shelf of storage bins out from the cabinet. Once the collection of bins has been slid out of the cabinet, each bin may be accessed by laterally removing or inserting the bin into the hangers of the hanger plate.

U.S. Patent Application No. 2010/0,089,848 to Thompson describes a rotatable spice carriage for holding and organizing miniature spice containers. The spice rack has multiple tiers of circular, ring-shaped spice holding racks that are stackable about a central spindle. Each ring has multiple semi-cylindrical compartments, each for holding a single miniature spice container such that several miniature spice containers are held by each ring. Each compartment is capable of gripping a miniature spice container, holding the container securely in place, thus the device can be oriented in either a vertical or horizontal configuration, while the spice containers will stay in their compartment until physically removed by a user. The rings of the device are staggered in relation to one another making it easy for a user to access and remove each spice container form the rack. The device is capable of being hung from the underside of a kitchen cabinet or stored on a counter top.

The Thompson device requires that the spices be transferred to the miniature storage containers from their original packaging. It is highly unlikely that the complete contents of a spice package will fit in one of the miniature spice containers of the Thompson device. Excess spice in the original packaging requires storage in a cabinet or drawer until the miniature container needs refilling. Thus, no kitchen storage space—i.e., cabinet or drawer—is saved by utilizing the Thompson device. Since an individual must store the collection of original spice containers in a cabinet or drawer, use of the Thompson device does not address, or remedy, the problems associated with the storage of the original containers. Another potential drawback of the Thompson device is that the device is intended to reside on a counter top or affixes to the underside of a kitchen cabinet, and thus is visible to anyone in the kitchen. However, it is not always desirable to have spices openly visible in a kitchen.

The present invention is an organization and storage system for an assortment of herb and spice containers. The device comprises of a series of frame shelving units upon which an individual can store spice containers in their original packaging. One embodiment of the present invention allows an individual to adjust the height associated with each shelf in the shelving frames. The device conceals the spice collection inside a kitchen cabinet and conserves cabinet space by employing multiple tiers of shelving in each of the frame shelving units. The spice containers store in a compact, vertical space inside the cabinet, increasing the overall amount of storage space in the cabinet.

U.S. Pat. No. 6,129,219 to Peickert describes a spice organization system for use in a kitchen drawer. The device is a tray, which inserts into the bottom of a kitchen drawer, which has an overall saw-tooth configuration, where the peaks and troughs are connected on one side by an angular rise and a sharp drop, which forms a right angle with the angular rise at the trough. The spice containers rest in the tray such that the bottom of each spice container rests in the trough with the container bottom touching the vertical drop of the trough and the backside of the spice container lying along the angular rise of the saw-tooth-shaped tray. The top of each spice container orients towards the peak of each angular rise. The spice containers are intended to be oriented such that the label for each spice is clearly visible when the drawer is accessed by an individual. Each angular rise of the tray is adorned with raised areas and depressed areas. The back of the spice container rests in the depressed area, which is flanked by two raised areas on either side to stabilize the spice container and prevent it from moving each time the drawer is accessed.

The Peickert device is intended for use in a kitchen drawer, which presents a limitation to the Peickert device as the height of the spice containers must not be so tall as to impede the ability of the drawer to properly close. A spice container that is too tall in height, when laid down in a saw-tooth shaped trough of the Peickert device, may exceed the length of the angular rise of the tray, thus extending too far above the tray and impacting the ability of the drawer to close. The present invention provides individuals with a spice storage system that is capable of accommodating a vast array of spices. One embodiment of the present invention utilizes uniform spice storage containers, which an individual transfers the spices to. The containers are uniform in appearance but can be of various sizes, some or all of which are sufficiently large as to store a large quantity of spice, thereby alleviating the need to store the original spice packaging somewhere else in the kitchen because the entire contents of the original spice packaging fits inside the uniform spice containers of the present invention. Another embodiment of the present invention allows for an individual to store spices in their original packaging on the shelves of the present invention.

It is therefore submitted that the present invention substantially diverges in design elements from the prior art and consequently it is clear that there is a need in the art for an improvement to existing spice container storage devices. In this regard the instant invention substantially fulfills these needs.

### SUMMARY OF THE INVENTION

In view of the foregoing disadvantages inherent in the known types of spice container organization and storage devices now present in the prior art, the present invention provides a new spice storage system wherein the same can be utilized for providing convenience for the user when accessing his or her assortment of herb and spice containers.

It is therefore an object of the present invention to provide a new and improved spice container organization and storage device that has all of the advantages of the prior art and none of the disadvantages.

Another object of the present invention is to provide individuals with a convenient, easy to navigate and space-saving spice container storage system for use in a kitchen cabinet or as an independent structure.

It is also an object of the present invention to provide a spice storage device that can either be built in to new kitchen cabinets, retrofit into existing cabinets, or placed on a countertop as an independent cabinet that provides a structure to house the slideable shelves that store the spice containers.

Yet another object of the present invention is to provide individuals with a spice storage system that provides a plurality of aligned and slideable shelves that are easily accessible from both sides when in an accessible position, and further have multiple tiers per shelving frame for which to store spice containers.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a perspective view of the present invention wherein a single shelving frame has been slid out from the cabinet structure into an accessible position.

FIG. 2 is a front view of the present invention in the storage position, wherein all shelving frames are inside the confines of the cabinet structure.

FIG. 3 is a perspective view of the present invention wherein a single shelving frame has been slid out from the cabinet structure into the accessible position. The present invention is holding a variety of spices in their original packaging of various sizes and shapes.

FIG. 4 is a perspective view of the present invention wherein each shelving frame has been slid out of the cabinet, presenting various degrees of accessibility to the spices contained therewithin.

### DETAILED DESCRIPTION OF THE INVENTION

Reference is made herein to the attached drawings. Like reference numerals are used throughout the drawings to depict like or similar elements of the spice storage device described. For the purposes of presenting a brief and clear description of the present invention, the preferred embodiment will be discussed as used for storing spice containers. The figures are intended for representative purposes only and should not be considered to be limiting in any respect.

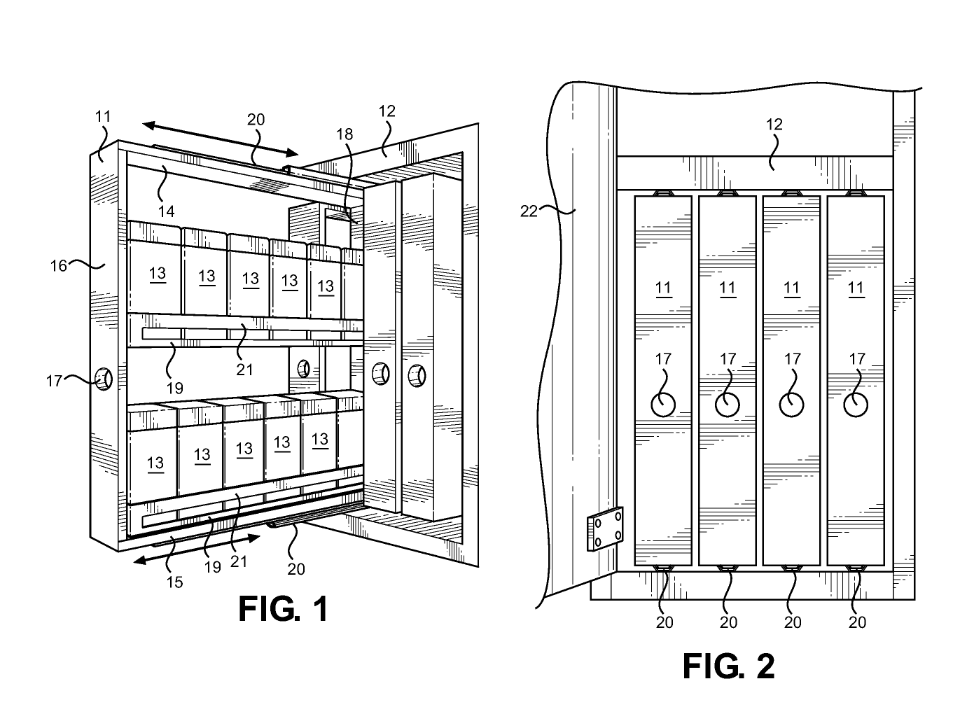

Referring now to FIG. 1, there is shown a perspective view of an embodiment of the present invention. The present invention is a series of square or rectangular shelving frames 11 that are aligned adjacent to one another in a cabinet structure 12 for the storage of spice containers 13. A small gap exists between each of the adjacent shelving frames 11 in the series such that the shelving frames freely slide into and out of the cabinet without impacting one another. Each frame has a top 14; a bottom 15; a front side 16 with a shelf removal means 17 thereon that serves as a handle to pull the frame 11 out from the cabinet 12; along with a back side 18 that faces the interior of the cabinet structure 12 in which the device is housed. The shelf removal means 17 may be an ornamental handle or a simple cutout finger grip hole, depending on user tastes and desire. Each shelving unit has an interior and an exterior. There are multiple shelves 19 contained within the interior of each frame 11. The top exterior side 14 and/or the bottom exterior side 15 of the frames 11 mount onto independent sliding drawer guides 20 inside the cabinet 12, enabling an individual to slide each frame 11 out from the cabinet 12 separately to access the plurality of spice containers 13 that are held in each shelving frame. The shelving frames are open on both sides of the frame, and thus the spice containers are accessible from either side of the shelving frame. Above each shelf on either side there are railings 21 that create an open channel within each shelf to keep the spice containers from accidentally falling out of the device when an individual accesses the shelf. A vast assortment of spices can be stored and organized in the present invention. The containers can be organized alphabetically or by frequency of use during cooking or baking, or by any order desired by the user.

Each shelving frame of the present invention has two positions: a storage position and an accessible position. A shelf is in the storage position it is slid back into the cabinet such. An external cabinet door may be provided or utilized to conceal the shelves when in a storage position. The storage position renders the spice containers stored on the shelves of each frame inaccessible to an individual. Conversely, the shelves are in the accessible position when an individual opens the optional cabinet door and slides a shelving frame out of the cabinet a sufficient distance as to enable an individual to access the desired spice containers. An individual may not have to slide the shelving frame completely out from the cabinet to be able to access the desired spice container. For example, an individual may only need to slide a shelving frame out halfway to gain access to a container of nutmeg or cinnamon. When the device is in the accessible position, there are varying degrees of access to the spices. The present invention can either be built in to a new kitchen cabinet, retrofit into an existing cabinet, or be provided as an independent structure that can be placed on a kitchen countertop for use in residential, commercial or industrial kitchen. The device can also be used in upper cabinets, thus placing the spice rack library at eye-level, on the countertop, or in a lower cabinet as desired.

Located at the top 14 and/or bottom 15 of each shelving frame 11, there are drawer guides 20 that attach the shelving frames 11 to the cabinet 12 and allow for the shelving frames to easily slide into and out of the cabinet. The drawer guides limit how far the shelving frame can slide out from the cabinet, i.e., the drawer guides prevent the frame from sliding so far as to fall out of the guides and thus the cabinet. Also, to prevent spice containers from accidentally falling out of the device while an individual accesses the frame shelving unit, each shelf is equipped with railings 21 on either side of the shelf. The railings stabilize the spice containers. One embodiment of the present invention allows for the height of the railings to be adjustable as to accommodate tall spice containers.

Along the front side of each shelving frame, there is a shelf removal means 17 which serves as a grip for pulling the shelving frame 11 out of the kitchen cabinet 12 into an accessible position. An individual grasps a handle or inserts his or her finger into a finger hole, hooking his or her finger on the frame from inside of the finger grip hole and then pulling the shelving frame out from the cabinet and into the accessible position.

Referring now to FIG. 2, there is shown a perspective view of the present invention in the storage position. To achieve the storage position, the shelving frames 11 are all slid into the cabinet 12 such that the frames are within the confines thereof. An individual may utilize the removal means 17 to push the shelving frames 11 into the cabinet, or can push on the front side of the shelving frame. In the inaccessible position, the cabinet door 22 is capable of closing and concealing the series of frame shelving units 11 inside the cabinet. In this configuration, an individual's spice collection is hidden from view. Along the shelving frame outer surface may be mounted a labeling area for which to record or place labels that correspond to each spice or article on a given shelf. In an embodiment of the present invention, the drawer guides 20 are attach only to the bottom of each frame. The drawer guides attach the shelving frames to the bottom of the cabinet. In an alternate embodiment, the drawer guides 20 are mounted to a mounting plate that is a length equal to the guides and a width adapted to allows side-by-side mounting of several drawers wherein the mounting plates abut each other and provide the necessary lateral offset required to access each shelf. In this way, the mounting plate reduces the effort required to equally and adequately space each shelf. Two plates are connected to the cabinet top and bottom, respectively, and provide a mounting location to attach an upper and lower draw guide.

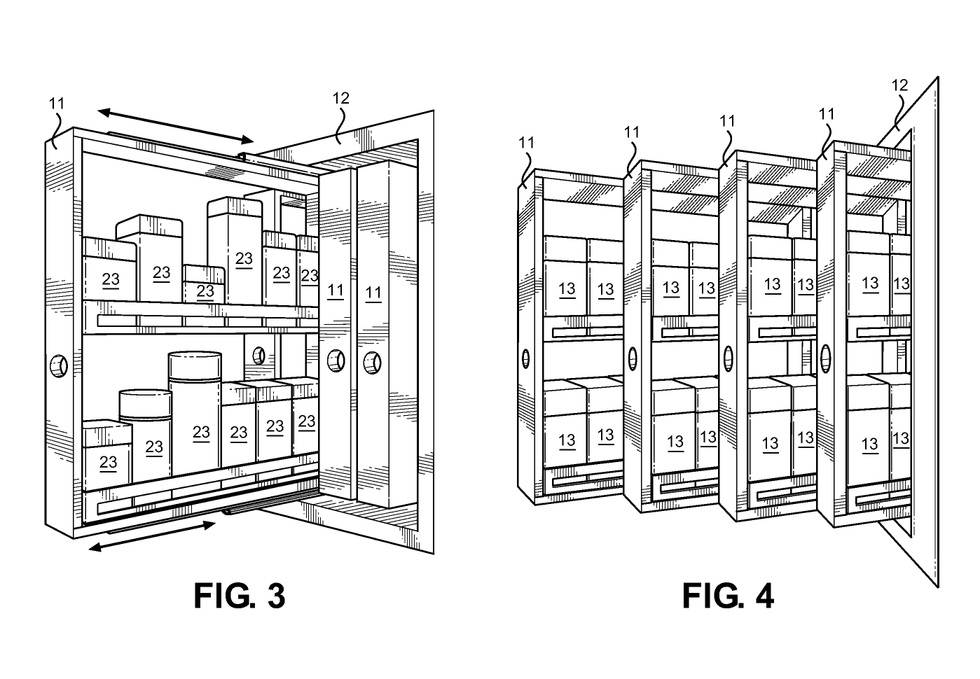

Referring now to FIG. 3, there is shown a perspective view of a single shelving frame 11 in the accessible position. The device is shown as holding a variety of spice containers 23 in their original packages of various size and shape. Some spice containers are rectangular in shape, others have a cylindrical appearance. One embodiment of the present invention incorporates a means of adjusting the height of the shelves in each of the shelving frames. Adjustable shelving enables an individual to customize the shelving unit to best accommodate the individual's collection of herb and spice containers as the original packaging of many spices vary in height. For example, an industrial or commercial kitchen may use a large quantity of a particular spice frequently, and thus a cook requires a large quantity of the spice on hand. The present invention can be manufactured in different sizes as to best suit the needs associated with residential, commercial and industrial kitchens.

Referring now to FIG. 4, there is shown a perspective view of an embodiment of the present invention where the height of the shelves is fixed and a system of identical spice containers 13, which are uniform in appearance and size, are in use for holding various spices. Each shelving frame 11 is slid out of the cabinet 12, presenting various degrees of accessibility to the spices contained there within. This embodiment of the present invention utilizes uniform spice storage containers 13, which an individual transfers the spices to from their original packaging. The storage containers are uniform in appearance but can vary in size, some or all of which are sufficiently large as to store a large quantity of spice, thereby alleviating the need to store the original spice packaging somewhere else in the kitchen. Additionally, if the entire contents of the original spice packaging do not fit inside a single uniform spice container, the excess spice can be stored in a second uniform spice container until needed to refill the primary uniform spice storage container.

A spice container holding system comprising of a series of frame shelving units, arranged adjacent to one another, that slide in to and out of a cabinet structure, granting access to the spices that are stored upon the shelves from either side of the shelving unit is described. On the top and bottom of each frame there are drawer guides that attach the frames to the cabinet. The drawer guides allow for the frames to slide into and out of the kitchen cabinets easily. The frame comprises of multiple shelves and each shelf has railings on either side to keep the spice containers from accidentally falling out of the device while an individual accesses the shelf. A plurality of spice containers can be held on each shelf. The device conserves cabinet space by employing multiple tiers of shelving in each of the shelving frames. The spice containers are stored in a compact, vertical space inside the cabinet, increasing the overall amount of storage space in the cabinet.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An organization and storage system for an assortment of containers, comprising:
a plurality of frame shelving units having a top, a bottom, a front side and a back side slideably aligned within a cabinet structure;
said shelving units having an interior and an exterior;
said shelving front side having a shelf removal means located along each shelving front side;
said back side facing the interior of said cabinet structure;
said frame shelving units slideably attaching to said cabinet structure via drawer guides;
each frame shelving unit having a plurality of shelves;
each shelf having railings to create a channel adapted to accept a plurality of containers;
each of said frame shelving units having a first and second position: a storage position, whereby said frame shelving units slide into said cabinet structure, and an accessible position whereby a frame shelving unit is slid out of said cabinet making said containers accessible.

2) The device of claim 1, wherein said cabinet structure is an independent structure having sidewalls and a back wall.

3) The device of claim 1, wherein said shelf removal means further comprises a finger grip hole.

4) The device of claim 1, wherein said shelf removal means further comprises a handle grip.

5) The device of claim 1, wherein said cabinet structure further comprises a hingeable cabinet door to conceal said slideable shelving units.

6) The device of claim 1, wherein said plurality of frame shelving units mount inside said cabinet structure such that a gap exists between each adjacent frame shelving unit to reduce interference.

7) The device of claim 1, further comprising a drawer guide mounting plate that provides equal spacing of adjacent guides and an attachment to said cabinet structure.

8) The device of claim 1, wherein said drawer guides are located on said top exterior side and said bottom exterior side of said frame shelving unit to attach said frame shelving unit to said cabinet.

9) The device of claim 1, wherein said shelves of said frame shelving unit are capable of being positioned at varying heights within said frames.

10) The device of claim 1, further comprising a label area on said shelving front side for indicating or recording said shelf contents.
